(19) United States
(12) Patent Application Publication
(10) Pub. No.: US 2017/0125802 A1
(43) Pub. Date: May 4, 2017

(54) METHODS FOR MAKING CONFORMATIONAL CONDUCTIVE COATED MATERIALS

(71) Applicant: The Regents of the University of California, Oakland, CA (US)

(72) Inventor: David Kisailus, Riverside, CA (US)

(21) Appl. No.: 15/338,248

(22) Filed: Oct. 28, 2016

Related U.S. Application Data
(60) Provisional application No. 62/247,704, filed on Oct. 28, 2015.

(51) Int. Cl. H01M 4/36; H01M 4/583; H01M 4/04; H01M 10/0525

(52) U.S. Cl. CPC H01M 4/366; H01M 10/0525; H01M 4/583; H01M 4/0414; H01M 4/0471; H01M 2004/028

(57) ABSTRACT

The disclosure provides a method for conformationally conductively coating materials, the coated materials resulting therefrom, and the use of the coated materials for various applications, including in Li-ion batteries.

### CROSS REFERENCE TO RELATED APPLICATIONS

This application claims priority under 35 U.S.C. §119 from Provisional Application Ser. No. 62/247,704, filed Oct. 28, 2015, the disclosure of which is incorporated herein by reference.

### TECHNICAL FIELD

The disclosure provides a method for making conformationally conductive coated materials, the coated materials resulting therefrom, and the use of the coated materials in various applications and devices.

### BACKGROUND

Li-ion batteries have an outer case made of metal. This metal case holds a long spiral comprising three thin sheets pressed together: a positive electrode, a negative electrode and a separator. These sheets are submerged in an organic solvent that acts as the electrolyte, all within the metal case. The separator is a thin sheet of microperforated plastic. As the name implies, it separates the positive and negative electrodes while allowing ions to pass through. In many electric vehicles, the cathode material is a poor electrical conductor (e.g., LiFePO₄).

### SUMMARY

The disclosure provides a method to produce ultrathin conformal conductive coatings on nano- and micro-sized materials using a low-cost process that allows for tuning of the thickness of the coatings. The disclosure further provides for materials which have been conductively coated by the methods disclosed herein. The disclosure also provides the use of conductively coated materials in batteries, such as Li-ion batteries, or in any application where it is desirable for an insulating material to have an electrically and/or thermally conductive coating.

In a particular embodiment, the method disclosed herein can be used to make electrically conductive, thin coatings on nano- and micro-sized materials used in Li-ion technologies. In a further embodiment, the method allows for the production of ultrathin carbon coatings on LiFePO₄ (“LFP”), an insulating material used as a cathode in Li-ion batteries.

In the methods disclosed herein, a polymer is first dissolved in an appropriate solvent and then the material to be coated (e.g., LHP) is added to the solution under mixing. The polymer used in the methods disclosed herein should contain functional groups capable of binding to the surface of nano- and micro-sized materials. As the materials to be coated are added to solution, the polymer molecules bind to the materials, producing a thin organic layer around each material. After which, the organic-coated materials are then separated and passed through a furnace under an inert atmosphere to pyrolyze the organic molecules, yielding a thin, conformal carbon coating that is electrically conductive, while being thin enough to enable ion transport into and out of the material.

In a particular embodiment, the disclosure provides a method to generate a conformational conductive coating on particles comprising the steps of: adding a plurality of particles to a solution comprising an organic polymer dissolved in one or more solvents; incubating the particles in the solution until a coating of the organic polymer forms on the surface of the particles; isolating the organic polymer-coated particles; and pyrolyzing the organic polymer-coated particles in an inert and/or reducing atmosphere at 200° C. to 800° C. for 1 to 24 hours so that the organic polymer coating anneals and decomposes to form a conformal carbon coating that is electrically conductive on the surface of the particles that is 0.5 nm to 10 nm in thickness, wherein the particles are nano- to micron-sized particles that are comprised of an insulating material used for anodes or cathodes. In a further embodiment, the one or more solvents comprise a polar protic solvent. Examples of polar protic solvents include, but are not limited to aqueous-based solvents (i.e., solvents which comprise water), alcohols, formic acid, and ammonia. In yet a further embodiment, the organic polymer is selected from the group consisting of poly(vinyl alcohol), polyethylene, poly(butyl methacrylate), poly(α-methylstyrene), polyethylene glycols, polystyrene, polypropylene, polytetrafluoroethylene, polychlorotrifluoroethylene, para-aramid, polychloroprene, polyamide, polyacrylonitrile, copolyamid, polytetrafluroethylene, polyimide, aromatic polyester, poly-p-phenylene-2,6-benzobisoxazole, poly-4-vinylphenol, poly(2,6-diphenylphenylene oxide), poly(3,4-ethylenedioxythiphene), poly(hexamethylene carbonate), poly(hydridocarbyne), poly(methacrylic acid), poly(N-vinylacetamide), poly(p-phenylene oxide), polyphenylene sulfide, poly(p-phenylene vinylene), polyacetylene, polyallylamine hydrochloride, polyaniline, polyaniline nanofibers, polyaryletherketone, polybenzimidazole fiber, polybutadiene, polydiacetylenes, polydioctylfluorene, polyetherketoneketone, polyglycerol, polyricinoleate, polyhexahydrotriazine, polyhexamethylene guanidine, polyketone, polymacon, polymethylpentene, polyol, polybenzyl isocyanate, polypyridinium salts, polypyrrole, polystyrene sulfonate, polythiophene, cellulose, chitin, glycogen, polypeptides, polynucleotides, and polysaccharides. In a particular embodiment, the polymer is polyethylene glycol or a functionalized polyethylene glycol. In another embodiment, the solution comprises 5% to 30% by weight of polyethylene glycol or a functionalized polyethylene glycol. In a further embodiment, the plurality of particles is added from a suspension comprising evenly dispersed particles. In yet a further embodiment, the suspension comprises from 0.5% to 10% by weight of the particles in a polar protic solvent. In another embodiment, the suspension is added drop by drop to an agitated solution comprising the organic polymer dissolved in one or more solvents. In a further embodiment, the solution comprising the particles and polymer is incubated under agitation for 0.5 hours to 3 hours at 15° C. to 30° C. In yet a further embodiment, the particles are isolated by centrifugation, by aggregation with salt, by sedimentation, and/or by evaporation. In another embodiment, the particles are dried prior to the heating step. Drying can affected by drying under vacuum at ambient temperature or at an elevated temperature, air drying at ambient temperature or at an elevated temperature, or drying in an oven at an elevated temperature. In a particular embodiment, the particles are comprised of LiFePO₄. In a further embodiment, organic polymer-coated particles are pyrolyzed under a flowing 95% N₂/5% H₂ forming gas. In yet a further embodiment, the organic polymer-coated particles are pyrolyzed at about 600° C. for two to four hours. In a certain embodiment, the carbon coating is evenly distributed over the particle' surface, and wherein the carbon content of the carbon coated particle is less than 1% by weight.

In a particular embodiment, the disclosure provides for conformational conductive coated particles made by the method disclosed herein. In a further embodiment, the conformational conductive coated particles exhibit one or more of the following characteristics: a carbon coating from about 1 nm to 2 nm; a large portion of the coating is graphitic versus disordered carbon; a crystal size from 42 to 80 nm; a G/D ration of about 1.30; a particle size from 300 nm to 620 nm; and/or a rate capability of about 80 mA h/g at 2 C. In yet a further embodiment, the conformational conductive coated particle exhibit the following characteristics: a carbon coating from about 1 nm to 2 nm; a large portion of the coating is graphitic versus disordered carbon; a crystal size from 42 to 80 nm; a G/D ration of about 1.30; a particle size from 300 nm to 620 nm; and a rate capability of about 80 mA h/g at 2 C. In another embodiment, the disclosure provides for an anode and/or cathode which comprises conformational conductive coated particles described herein. In yet another embodiment, the disclosure further provides a lithium ion battery which comprising a cathode and/or an anode disclosed herein.

In a particular embodiment, the disclosure also provides for conformationally conductively coated particles resulting from the methods disclosed herein. In particular, the used of these conductively coated particles in Li-ion batteries.

### DESCRIPTION OF DRAWINGS

FIG. 1 presents an initial coating process.

FIG. 2 presents a schematic showing the binding of the polymer to a particle.

FIG. 3 presents a process to collect and pyrolyze organic coatings to make carbon coatings.

FIG. 4 presents X-ray diffraction patterns for as-synthesized LFP annealed in 95% N₂/5% H₂ for three hours at (Line A) 200° C., (Line B) 300° C., (Line C) 400° C., (Line D) 500° C., (Line E) 600° C., and (Line F) 700° C.

FIG. 5A-F presents scanning electron microscope (SEM) micrographs of as-synthesized LFP annealed in 95% N₂/5% H₂ for three hours at (A) 200° C., (B) 300° C., (C) 400° C., (D) 500° C., (E) 600° C., and (F) 700° C.

FIG. 6 presents an SEM micrograph of solution-coated PEG on as-synthesized LFP.

FIG. 7 presents a SEM micrograph of carbon-coated LFP (from PEG) after annealing at 600° C. in 95% N₂/5% H₂ for three hours at 20 cc/min.

FIG. 8 presents an X-ray diffraction pattern of PEG-based LFP after annealing at 600° C. for 3 h in 95% N₂/5% H₂ at 20 cc/min.

FIG. 9 presents a Raman spectrum of PEG-based LFP after annealing at 600° C. in 95% N₂/5% H₂ for 3 hours at 20 cm³/min.

FIG. 10 presents a SEM micrograph for sucrose-added LFP mixture after annealing at 600° C. in 95% N₂/5% H₂ for 3 hours at 20 cc/min.

FIG. 11A-C provides the CV profiles of LFP in the voltage range of 2.7-4.2 V at a scan rate of 0.1 mV/s for (A) PEG-based carbon-coated LFP, (B) sucrose-based carbon-coated LFP, and (C) uncoated LFP control.

FIG. 12A-B demonstrates the discharge capacity vs cycle number for PEG-based carbon-coated LFP. (A) Cycling performance at 0.1 C between 2.7 and 4.2 V (vs Li⁺/Li) for 70 cycles, (B) discharge capacity retention.

FIG. 13 demonstrates the cycling performance of carbon-coated and carbon-free LFP at various current rates between 2.7 and 4.2 V (vs Li⁺/Li). (Sample A-squares) PEG-based carbon-coated LFP, (Sample B-circles) sucrose-based carbon-coated LFP, and (Sample C-triangles) uncoated LFP control.

FIG. 14 shows TGA/DSC of as-synthesized LiFePO₄ from 25° C. to 700° C. and held at 700° C. for three hours at 20 cc/min flow rate in 95% N₂/5% H₂.

FIG. 15A-B presents TGA/DSC curves for PEG and sucrose heated in 95% N₂/5% H₂ flowing at 20 cc/min. (A) PEG from 25° C. to 700° C. and held for three hours at 700° C., (B) sucrose from room temperature to 600° C. and held at 600° C. for 3 hours.

FIG. 16A-D provides a Raman spectroscopy of PEG annealed in 95% N₂/5% H₂ at 20cc/min for 3 hours at: (A) 400° C., (B) 500° C., (C) 600° C., and (D) 700° C.

FIG. 17A-B shows Raman spectroscopy of sucrose annealed under 95% N₂/5% H₂ at 20 cc/min for 3 hours at: (A) 500° C., and (B) 600° C.

FIG. 18 presents a TEM micrograph of PEG-based carbon-coated LFP after annealing at 600° C. for 3 hours in 95% N₂/5% H₂ at 20 cc/min (sample A). The arrows highlight a surface coating of carbon.

FIG. 19 provides an X-ray diffraction pattern of sucrose-coated LFP after annealing at 600° C. for 3 hours in 95% N₂/5% H₂ at 20 cc/min.

FIG. 20 provides a Raman spectroscopy of sucrose-coated LFP annealed at 600° C. for 3 hours in 95% N₂/5% H₂ at 20 cc/min.

### DETAILED DESCRIPTION

As used herein and in the appended claims, the singular forms “a,” “an,” and the include plural referents unless the context clearly dictates otherwise. Thus, for example, reference to “a polymer” includes a plurality of such polymers and reference to “the metal salts” includes reference to one or more metal salts and equivalents thereof known to those skilled in the art, and so forth.

All publications mentioned herein are incorporated by reference in full for the purpose of describing and disclosing the methodologies, which might be used in connection with the description herein. Moreover, with respect to any term that is presented in one or more publications that is similar to, or identical with, a term that has been expressly defined in this disclosure, the definition of the term as expressly provided in this disclosure will control in all respects.

Unless defined otherwise, all technical and scientific terms used herein have the same meaning as commonly understood to one of ordinary skill in the art to which this disclosure belongs. Although many methods and reagents similar or equivalent to those described herein can be used, the exemplary methods and materials are described herein.

In 1991, Sony commercialized the first lithium-ion battery, which used carbon as the anode and LiCoO₂ as the cathode. Since then, a large amount of effort has been expended in the past two decades to improve the battery performance in terms of the energy density and rate capacity from both anode and cathode aspects. These improvements on anode research range from the introduction of using Si nanowires to using metal oxide hollow structures, nanoparticles, nanofibers, and thin films. The disclosure provides for a cathode made from LiFePO₄. One drawback of using LiFePO₄ (LFP) is its low rate capacity, which is due to the poor electronic conductivity and low lithium ion diffusivity. These disadvantages inhibit its broader commercial utilization. One way to overcome this inherent deficiency is to reduce the path length for Li-ion diffusion by reducing the particle size. Alternatively, the conductivity of the particles can be modified by either coating the surface (e.g., with carbon or silver) or by doping the lattice (i.e., cationic/anionic doping). Among all of the different surface modifications, carbon-coated LFP has been the most intensively studied. Previous research on carbon-coated materials has proven successful to improve battery performance. However, small amounts of carbon additive will result in the unrealistically low energy density. For example, Chen et al., determined that the addition of 2.5 wt % carbon would reduce the tap density from 1.9 to 1.05 g/cm, resulting in more than 40% reduction in volumetric density. Therefore, extremely low (less than 1 wt %) carbon additives are desired. In addition to the amount of carbon, its structure can affect performance in batteries. Increasing the ratio of sp²-(graphitic) to sp³-(disordered) carbon will benefit the electronic conductivity. Thus, it is important to produce high-quality graphitic carbon coatings with minimal loading. Provided herein is coating cathode materials using a polymer solution, which subsequently yields thin and uniformly polymer-coated particles that are annealed to form carbon coatings. The methods presented herein are advantageous over conventional mechanochemical activation methods that produce heterogeneous and thick carbon coatings. The disclosure demonstrates the use of a polyethylene glycol (PEG) polymer as the carbon source to coat the polycrystalline LFP. Aqueous-based polyethylene glycol solutions have been widely used. Their low toxicity and volatility, as well as their biodegradability, represent important environmentally benign characteristics, which are particularly attractive when combined with their relatively low cost as a bulk commodity chemical. Herein, PEG was used as a surfactant in LFP suspensions to form core-shell structures, subsequently transforming the surface to a thin coating with very low (less than 0.5 wt %) carbon content after annealing. The electrochemical performance of this material compared to a sucrose-based carbon coated LFP was analyzed further herein.

Current processes to make LiFePO₄ (“LFP”) cathode materials more conductive, utilize mixing the LFP particles with an organic, such as sucrose, that is then pyrolyzed under an inert or reducing atmosphere. The resultant LFP particles are thickly coated with a carbonaceous coating, which makes them conductive. The processes, however, are inefficient and produce thick, nonhomogeneous carbon coatings that not only reduce the packing density of the LFP in the battery, but also inhibit Li-ions from diffusing in and out of the LFP. Accordingly, the thickly coated LFP particles produced by these processes have a reduced energy density (i.e., the amount of energy stored in one charge), and a reduced charging and discharging rate (i.e., power density). By contrast, the conductive coating produced by the methods of the disclosure, produce a thin, conformal carbon coating that is electrically conductive, while being thin enough to enable ion transport into and out of the LFP.

The disclosure provides methods for the production of electrically conductive materials from otherwise insulating materials by coating the insulating material with a conductive layer. The disclosure further provides that the electrically conductive materials resulting from the methods disclosed herein can be used in batteries for a variety of devices, vehicles, aircraft, and large scale energy storage/usage applications (i.e., wind farms, nuclear power plants, industrial generators, and solar arrays). Additionally, the electrically conductive materials resulting from the methods disclosed herein can be used in any application where it is desirable that the insulating material have an electrically and thermally conductive coating (e.g., site specific heat sinks using carbon coated nanorods).

For purposes of this disclosure “polymer” refers to large molecules, or macromolecules, composed of many repeating subunits. Accordingly, a “polymer” as used herein does not refer to small molecules that are comprise of a relatively few number subunits that have been chemically bonded together, such as disaccharides (e.g., fructose, sucrose, etc.). Further, a “polymer” as used herein refers to both organic polymers and inorganic polymers, unless provided for otherwise. For example, use of the term “organic polymer” would refer to those polymers that have or substantially have a polymer backbone comprised of carbon atoms while the term “inorganic polymer” would refer to those polymers that have or substantially have a polymer backbone comprised of non-carbon atoms, e.g., Si atoms. Examples of organic polymers include, but are not limited to, poly(vinyl alcohol), polyethylene, poly(butyl methacrylate), poly(α-methylstyrene), polyethylene glycols (e.g., PEG, TEG), polystyrene, polypropylene, polytetrafluoroethylene, polychlorotrifluoroethylene, para-aramid, polychloroprene, polyamide, polyacrylonitrile, copolyamid, polytetrafluroethylene, polyimide, aromatic polyester, poly-p-phenylene-2,6-benzobisoxazole, poly-4-vinylphenol, poly(2,6-diphenylphenylene oxide), poly(3,4-ethylenedioxythiphene), poly(hexamethylene carbonate), poly(hydridocarbyne), poly(methacrylic acid), poly(N-vinylacetamide), poly(p-phenylene oxide), polyphenylene sulfide, poly(p-phenylene vinylene), polyacetylene, polyallylamine hydrochloride, polyaniline, polyaniline nanofibers, polyaryletherketone, polybenzimidazole fiber, polybutadiene, polydiacetylenes, polydioctylfluorene, polyetherketoneketone, polyglycerol, polyricinoleate, polyhexahydrotriazine, polyhexamethylene guanidine, polyimide, polyketone, polymacon, polymethylpentene, polyol, polybenzyl isocyanate, polypyridinium salts, polypyrrole, polystyrene sulfonate, polythiophene, cellulose, chitin, glycogen, polypeptides, polynucleotides, and polysaccharides. Examples of inorganic polymers include, but are not limited to, poly(dimethylsiloxane), polymethylhydrosiloxane, polydiphenylsiloxane, polysilazane, polyborazylene, and polyaminoborane.

In the methods disclosed herein, a polymer (e.g., carboxymethyl cellulose) is first dissolved in an appropriate solvent (e.g., polar protic solvent, nonpolar solvent, nonprotic solvent, etc.) and the materials to be coated, such as LFP, are then added to the solution. The percent weight of polymer in the solution is from about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25%, about 30%, about 35%, about 40%, about 45%, about 50%, or any range between any two of the foregoing numbers. Preferably, the solution containing the materials and polymers should be agitated (i.e., by stirring). As the materials are added to solution, the polymer molecules bind to the surface of the material, producing a thin organic layer. After which, the organic-coated materials are isolated and then passed through a furnace under an inert atmosphere to pyrolyze the organic molecules. The resulting thin, conformal carbon coating is electrically conductive, while being thin enough to enable ion transport into and out of the materials.

In a particular embodiment, the disclosure provides a method for producing a conformational conductive coating utilizing a step of making a solution of polymer molecules that contain binding moieties (i.e., pendant groups) which have high affinity for atoms on the surface of the materials to be coated (e.g., Fe cations on each crystal facet of LHP materials). Accordingly, many different types binding moieties can be used in the methods disclosed herein, including, but not limited to, amino groups, carboxylates, phosphates, sulfates, and other heteroatom containing functional groups, as well as, mixtures the foregoing. In a particular embodiment, polymers with carboxylate based binding moieties (e.g., carboxymethyl cellulose) are used in a method disclosed herein (e.g., see FIG. 2). Carboxylates are efficient in forming interactions with metal cations and after pyrolysis likely will not produce any residue that would impede electron or ion transport.

In a further embodiment, polymers used in a method disclosed herein can have a backbone that is linear, aromatic, or a mixture thereof. It can be expected, however, that a linear backbone polymer will favorably undergo pyrolysis at a lower temperature, while a polymer with an aromatic backbone would require higher pyrolytic temperatures but would favorably produce more conductive carbon coatings, including graphene-like coatings. The molecular weight of the polymer can be controlled in order to modify the pyrolysis temperature, with lower molecular weight polymers producing lower temperature pyrolysis schedules. Typically, the polymer backbone is carbonaceous but could also be made of other conductive materials, including, but not limited to, metal oxides, metal nitride, and metal sulfides.

In another embodiment, a polymer is dissolved in a solvent so as to form a polymer containing solution. The solvent can be any solvent known in the art as long as the polymer is soluble in the solvent. The solvent should further enable dispersion of the materials so that they do not aggregate during the coating step.

The disclosure further provides that the materials to be conformationally conductive coated can be of any shape, including, but not limited to, spherical, cubic, plate-like, rod-like, and tube-like. Moreover, the materials (e.g., particles) can vary in size from 1 nm to 100 μm, and can be monodisperse or polydisperse.

In a particular embodiment, the disclosure also provides for a method disclosed herein, where the concentration of particles in a suspension or slurry can be modified from very dilute (e.g., 0.001 wt %) to ultra-concentrated (e.g., 70 wt %). In a particular embodiment, the suspension comprises by percent weight of particles of about 0.001%, about 0.01%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 10%, about 15%, about 20%, about 25%, about 30%, about 40%, about 50%, about 60%, about 75%, or any range between any two of the forgoing numbers. Generally, mixing should be performed with a stir speed of at least 500 rpm. It should also be understood that the solution containing the polymer and particles can be agitated in a different manner (e.g., placing the solution on a rocker, rotating wheel, or shaking by hand). The temperature at which the solutions and suspensions are maintained can be as low as the freezing point of the solvent or as high as the point in which the solvent undergoes decomposition. The viscosity can be varied by changing the polymer and particle concentration or by adjusting the solvent system.

The disclosure further provides for a method disclosed herein where the annealing step is performed at an elevated temperature under an inert or reducing atmosphere. Examples of inert and/or reducing atmospheres include, but are not limited to, argon, nitrogen, a mixture of hydrogen and nitrogen (e.g., 80-99% N₂/1-20% H₂), and a mixture of argon and hydrogen (e.g., 80-99% Ar/1-20% H₂). While the annealing temperature can vary, it should be at a high enough temperature so as to pyrolyze the organic polymer (e.g., at least 200° C.), but should not be high enough (e.g., >1800° C. for refractories) to cause significant grain growth of the inorganic nanoparticles (i.e., surface area is lost so as to reduce grain boundaries for ion intercalation).

In a particular embodiment, the disclosure provides that the conformational conductive coating thickness can be modulated by modulating the concentration of the polymer (e.g., 0.1M), molecular weight of the polymer, functionality of the polymer, particle size, particle concentration, and time and/or temperature of the coating step. The conformational conductive coating thickness can range from ultrathin (e.g., ˜1 nm) to very thick (e.g., ˜100 microns). In a particular embodiment, the conformation conductive coating has a thickness of about 0.5 nm, about 0.75 nm, about 1 nm, about 1.5 nm, about 2 nm, about 2.5 nm, about 3 nm, about 3.5 nm, about 4 nm, about 4.5 nm, about 5 nm, about 5.5 nm, about 6 nm, about 6.5 nm, about 7 nm, about 7.5 nm, about 8 nm, about 8.5 nm, about 9 nm, about 9.5 nm, about 10 nm, about 10.5 nm, about 11 nm, about 11.5 nm, about 12 nm, about 14 nm, about 16 nm, about 18 nm, about 20 nm, about 25 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1000 nm, or any range between any two of the forgoing numbers. Of the many advantages of the methods and materials disclosed herein, is the ability to make controlled, conformal electrically conducting coatings on nano- or micro-sized materials (e.g., for Li-ion cathodes). The methods disclosed herein, can be scaled up to produce large quantities of structures and can even be incorporated into continuous processes, such as 1-line assembly of batteries. Moreover, the coating process can be carried out under relatively mild conditions (i.e., around neutral pH, moderate temperatures, and green solvents) and depending on which polymer is utilized, the temperature for annealing can be quite low for pyrolysis. In comparison to other methods, the method disclosed herein circumvents the bulky, grinding process used in producing carbon coatings that result in non-homogenous and thick coatings which reduce energy and power densities.

LFPs can be made by a number of methods. Described below is one example of making LFPs used in the methods and compositions of the disclosure.

In a certain embodiment, a method to make nanostructures disclosed herein comprises heating a reaction mixture formed by combining a solution containing a first metal salt with a solution containing a second metal salt. The method may further comprise one or more pH adjustment steps, polymer addition steps, and/or purification steps. In a further embodiment, a method disclosed herein involves dissolving a first metal salt in a solvent, dissolving a second metal salt in a solvent, combining the dissolved metal salts to form a reaction mixture, and then incubating the reaction mixture at room temperature or an elevated temperature for a sufficient period of time to allow for product formation (e.g., from about 2-48 hours, 2-24 hours, 2-10 hours, 5-10 hours, 2-4 hours and any range or numerical value of any of the foregoing). In another embodiment, the reaction mixture is placed inside an autoclave reaction vessel and heated to temperatures greater than 50° C., typically greater than 100° C., for a few hours (e.g., 2-5 hours). In a certain embodiment, a method disclosed herein may further comprise steps to adjust the pH of the solutions, steps to add polymers to the solutions or reaction mixture and/or add steps for purifying the resulting nanoparticles. Choice of the solvent/co-solvent systems, addition of specific polymers, and modifying the pH of the solutions, enables size and morphological control of the resulting nanostructures. Using a method disclosed herein, one can obtain lithium-iron phosphate nanocrystals with a controlled range of size and shapes. The advantages of the methods disclosed herein include, but are not limited to: (i) precise control of the shape and/or size of the nanostructures produced, (ii) the nanostructures produced can be used in batty cathodes with a need for fast charge times and potential for high tap densities, (iii) relatively inexpensive, and (iv) can be easily scaled up for industrial production.

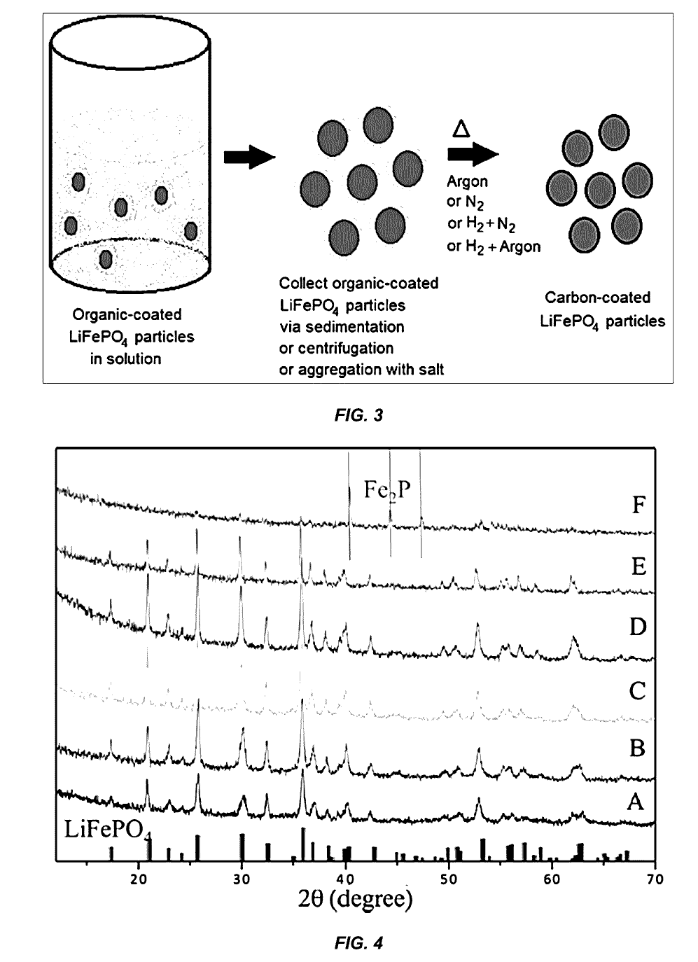

Using the methods disclosed herein, nanostructured lithium-iron phosphate (LFP) materials were produced in defined uniform shapes and sizes under mild temperatures (150° C.) and near-neutral pH within sealed reaction vessels (see, e.g., FIG. 2 and FIG. 3).

In a particular embodiment, a method disclosed herein comprises dissolving a first metal salt in one or more solvents. Typically, the first metal salt comprises a metal that is an alkali metal, alkaline earth metal, transition metal, post-transition metal, or lanthanide. In a further embodiment, the first metal salt comprises a transition metal. In a yet further embodiment, the first metal salt comprises a metal selected from the group comprising manganese, iron, titanium, zinc, copper, cobalt and nickel. In a certain embodiment, the first metal salt comprises iron. In another embodiment, the first metal salt comprises either a polyatomic anion or monoatomic anion. In a further embodiment, the first metal salt comprises a polyatomic anion and/or monoatomic anion selected from the group comprising sulfate, nitrate, phosphate, halide, dihydrogen phosphate, acetate, hydrogen sulfite, hydrogen sulfate, hydrogen carbonate, nitrite, cyanide, hydroxide, permanganate, hypochlorite, chlorate, perchlorate, hydrogen phosphate, oxalate, sulfite, carbonate, chromate, dichromate, silicate, molybdate, phosphite, diethyl carbonate, tetrafluoroborate, hexaflourophosphate, and triflate. In yet another embodiment the first metal salt comprises a polyatomic anion selected from the group comprising phosphate, sulfate, nitrate, molybdate, oxalate, chlorate, and carbonate. In a certain embodiment, the first metal salt comprises a polyatomic anion that is either sulfate, or phosphate. In yet another embodiment the first metal salt comprises a polyatomic anion that is a sulfate. In a particular embodiment, a first metal salt is dissolved in one or more solvents. In another embodiment, the first metal salt is dissolved in one or more polar solvents. In a further embodiment, a first metal salt is dissolved in one or more aqueous and/or non-aqueous solvents. In a further embodiment, a first metal salt is dissolved in one or more polar solvents comprising water, dihydroxy alcohols, alcohols, acetic acid, formic acid, ethyl acetate, tetrahydrofuran, dichloromethane, acetone, acetonitrile, dimethylformamide, dimethyl sulfoxide, and the like. In a further embodiment, a first metal salt is dissolved in mixture of solvents. In yet a further embodiment, a first metal salt is dissolved in water and/or a glycol, such as triethylene glycol (TEG). In a certain embodiment, a first metal salt is dissolved in water and TEG, wherein the water/TEG mixture can range from almost 99.9% water to almost 99.9% TEG with specific volumetric ratios in between depending on desired product.

In a certain embodiment, a method disclosed herein comprises forming a reaction mixture comprising combining a solution containing a first metal salt with a solution containing a second metal salt. Typically, the second metal salt comprises a metal that is an alkali metal, alkaline earth metal, transition metal, post-transition metal, or lanthanide. In a further embodiment, a second metal salt comprises an alkali metal. In a certain embodiment, a second metal salt comprises lithium. In another embodiment, a second metal salt comprises either a polyatomic anion or monoatomic anion. In a further embodiment, a second metal salt comprises a polyatomic anion and/or monoatomic anion selected from the group comprising sulfate, nitrate, phosphate, halide, dihydrogen phosphate, acetate, hydrogen sulfite, hydrogen sulfate, hydrogen carbonate, nitrite, cyanide, hydroxide, permanganate, hypochlorite, chlorate, perchlorate, hydrogen phosphate, oxalate, sulfite, carbonate, chromate, dichromate, silicate, molybdate, phosphite, diethyl carbonate, tetrafluoroborate, hexaflourophosphate, and triflate. In another embodiment, a second metal salt comprises hydroxide, perchlorate, carbonate, diethyl carbonate, tetrafluoroborate, hexaflourophosphate, or triflate. In yet another embodiment, a second metal salt comprises a polyatomic anion that is hydroxide.

In a particular embodiment, a second metal salt is dissolved in one or more solvents. In another embodiment, a second metal salt is dissolved in one or more polar solvents. In a further embodiment, a second metal salt is dissolved in one or more aqueous and/or non-aqueous solvents. In a further embodiment, a second metal salt is dissolved in one or more polar solvents comprising water, dihydroxy alcohols, alcohols, acetic acid, formic acid, ethyl acetate, tetrahydrofuran, dichloromethane, acetone, acetonitrile, dimethylformamide, dimethyl sulfoxide, and the like. In yet a further embodiment, a second metal salt is dissolved in mixture of solvents. In another embodiment, a second metal salt is dissolved in water and/or a glycol, such as triethylene glycol (TEG). In a certain embodiment, a second metal salt is dissolved in water and TEG, wherein this water/TEG mixture can range from almost 99.9% water to almost 99.9% TEG with specific volumetric ratios in between depending on desired product.

The ratio of the concentrations of a first metal salt with that of a second metal salt will primarily dictate the relative size of the nanostructures disclosed herein, wherein the higher the concentration of a first metal salt as it relates to a second metal salt, the smaller the resulting nanostructures. In a particular embodiment, the concentration of a first metal salt is equal to concentration of a second metal salt. In another embodiment, a second metal salt is used at a greater concentration than a first metal salt. In yet a further embodiment, the concentration of a second metal salt is used at least twice the concentration of a first metal salt. In another embodiment, the concentration of a second metal salt is at least three times the concentration of a first metal salt. In a certain embodiment, the concentration of a second metal salt is between two times to ten times the concentration of a first metal salt. In another embodiment, the concentration of a first metal salt is used at a greater concentration than a second metal salt. In a yet a further embodiment, the concentration of a first metal salt is used at least two times the concentration of a second metal salt. In another embodiment, the concentration of a first metal salt is used at least three times the concentration of a second metal salt. In yet another embodiment, the concentration of a first metal salt is used at between two times to ten times the concentration of a second metal salt.

In a particular embodiment, a method disclosed herein comprises a heating step/incubation step, where a reaction mixture is maintained at room temperature or at an elevated temperature (e.g., at least 25-50° C.), and where the reaction mixture is formed by combining a solution comprising a first metal salt with a solution comprising a second metal salt. In a certain embodiment, a reaction mixture is maintained at ambient temperature for at least 2-24 hours. In a certain embodiment, a reaction mixture is maintained at least 50° C. for at least about 2 hours. In another embodiment, a reaction mixture is maintained at least about 100° C. for at least about 2 hours. In yet another embodiment, a reaction mixture is maintained at least about 150° C. for at least about 2 hours. In a further embodiment, a reaction mixture is maintained at least about 200° C. for at least about 2 hours. In yet a further embodiment, a reaction mixture is heated in a sealed reactor, such as a Teflon™ or glass reactor.

In a further embodiment, a method disclosed herein further comprises one or more pH adjustment steps. In a particular embodiment, the pH of a solution comprising a first metal salt, the pH of a solution comprising a second metal salt and/or the pH of the reaction mixture, is adjusted by adding either an acid or base. In another embodiment, the pH of a solution comprising a first metal salt, the pH of a solution comprising a second metal salt and/or the pH of the reaction mixture, is adjusted by adding an acid. In a further embodiment, the pH of a solution comprising a first metal salt, the pH of a solution comprising a second metal salt and/or the pH of the reaction mixture, is adjusted by adding a multiprotic acid. In yet another embodiment, the pH of a solution comprising a first metal salt, the pH of a solution comprising a second metal salt and/or the pH of the reaction mixture, is adjusted by adding an aqueous acid solution. In a further embodiment, the pH of a solution comprising a first metal salt, the pH of a solution comprising a second metal salt and/or the pH of the reaction mixture, is adjusted by adding a nonaqueous and/or aqueous multiprotic acid solution including, but not limited to, phosphoric acid, sulfuric acid, carbonic acid, sulfurous acid, oxalic acid, malonic acid, or hydrogen sulfide acid. In yet a further embodiment, the pH of a solution comprising a first metal salt, the pH of a solution comprising a second metal salt and/or the pH of the reaction mixture, is adjusted with phosphoric acid. In another embodiment, the pH of a solution comprising a first metal salt, the pH of a solution comprising a second metal salt and/or the pH of the reaction mixture, is adjusted with aqueous sulfuric acid.

In a further embodiment, a method disclosed herein further comprises one or more polymer addition/incubation steps. For example, one or more polymers (e.g., polyvinyl pyrrolidone, polyacrylic acid) can be added to a solution comprising a first metal salt, a solution comprising a second metal salt and/or to the reaction mixture. In a particular embodiment, one or more polymers are added to the reaction mixture. In addition, the polymer can be modified to one that morphologically controls metals, metal nitrides, metal carbides, etc. The polymer can also be modified to be electrically conducting, allowing the production of electronic and optoelectronic devices. In a particular embodiment, the particles are incubated with the polymer under agitation for about 0.1 hours, about 0.2 hours, about 0.3 hours, about 0.4 hours, about 0.5 hours, about 1 hour, about 1.5 hours, about 2 hours, about 2.5 hours, about 3 hours, about 3.5 hours, about 4 hours, about 5 hours, about 6 hours, about 8 hours, about 12 hours, about 24 hours, about 48 hours, or any range between any two numbers of the foregoing; and at a temperature of about 10° C., about 12° C., about 15° C., about 20° C., about 25° C., about 30° C., about 35° C., about 40° C., about 50° C., or any range between any two numbers of the foregoing.

In a certain embodiment, a method disclosed herein further comprises one or more purification steps. Examples of purification steps include but are not limited to, removing solvents by evaporation, removing solvents by drying, filtering, trituration, extraction, sedimentation, size exclusion chromatography, preparative column chromatography, and the like.

The size and/or morphology of the nanostructures made by a method of the disclosure can be controlled by varying the water/TEG proportions, as well as, adjusting the pH of the solutions, adding specific polymers, adjusting the ratio of the metals, and the like. Thus, the properties and characteristics of the nanostructures disclosed herein can be tailored by specific reaction conditions. By adjusting such reaction conditions, the nanostructures will change in size and/or morphology. Examples of nanostructure morphologies include, but are not limited to, nanoparticles, nanoprisms, nanobelts, and nanocubes. In a certain embodiment, a method disclosed herein provides for the production of nanostructures that are uniform in size and/or morphology. In yet another embodiment, a method disclosed herein provides for nanostructures that are nanoparticles. In a further embodiment, a method disclosed herein provides for nanostructures that are nanoprisms. In yet a further embodiment, a method disclosed herein provides for nanostructures that are nanobelts. In a certain embodiment, a method disclosed herein provides for nanostructures that are nanocubes.

In a particular embodiment, a method disclosed herein provides for nanoparticles having a near uniform size distribution. In a certain embodiment, a method disclosed herein provides for nanostructures that are less than 100 μM in diameter. In yet another embodiment, a method disclosed herein provides for nanostructures that are less than 10 μM in diameter. In another embodiment, a method disclosed herein provides for nanostructures that are less than 1 μM in diameter. In a certain embodiment, a method disclosed herein provides for nanostructures that are less than 400 nM in diameter. In a further embodiment, a method disclosed herein provides for nanostructures that are less than 100 nM in diameter. In yet a further embodiment, a method disclosed herein provides for nanostructures that are less than 50 nM in diameter.

In a particular embodiment, a method disclosed herein provides for LFP nanoprisms that are 1 μm by 100 nm. In another embodiment, a method disclosed herein provides for LFP nanoparticles of 25 nm. In yet another embodiment, a method disclosed herein provides for 100 nm LFP nanocubes. In a certain embodiment, a method disclosed herein provides for 10 μm×400 nm×20 nm LFP nanobelts.

In another embodiment, the disclosure provides for one or more devices that comprise one or more nanostructures made by a method disclosed herein. In a further embodiment, one or more energy storage devices that comprise one or more nanostructures made by a method disclosed herein. In yet a further embodiment, an Li-insertion battery comprise one or more nanostructures synthesized using a method disclosed herein. In another embodiment, a cathode comprises one or more nanostructures made by a method disclosed herein.

The following examples are intended to illustrate but not limit the disclosure. While they are typical of those that might be used, other procedures known to those skilled in the art may alternatively be used.

### EXAMPLES

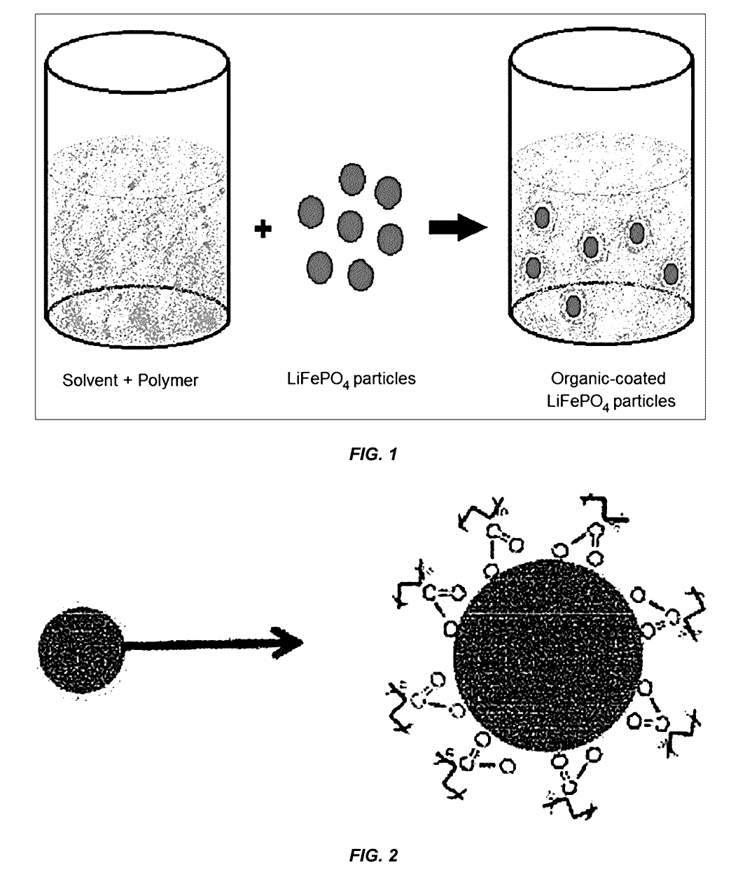

Method for making conformational conductive coatings on cathode particles: a polymer (e.g., caboxymethyl cellulose) is dissolved in an appropriate solvent (e.g., water), wherein the polymer has a desired functionality (e.g., free carboxylate groups) and molecular weight (see FIG. 1, left). A suspension comprising evenly dispersed cathode particles (e.g., LHP) in a suitable solvent is added to the polymer containing solution. Alternatively, cathode particles can be directly added to the polymer containing solution (see FIG. 1, middle). The particles are incubated in the polymer solution for a desired time, with or without agitation (e.g., stirring). As the concentration of polymer (e.g., 0.1M), functionality of the polymer, particle size, particle concentration, time and temperature of the incubation will dictate the resulting thickness of the organic layer; these variables can be adjusted accordingly. The organic coated particles (see FIG. 1, right; and FIG. 2) are separated and collected from the solvent system and unbound polymer (see FIG. 3, middle) by typical methods known in the art (e.g., by centrifugation, aggregation, or evaporation). The particles are dried to remove any remaining solvent using standard methods (e.g., by evaporation or by drying in vacuum oven). The dried organic-coated particles are placed in a furnace or other heating source under and inert or reducing atmosphere (e.g., under argon, nitrogen, argon and hydrogen, or nitrogen and hydrogen) at an elevated temperature to anneal and decompose the organic molecules to form a carbon coating (see FIG. 3, right).

Process to Synthesis Lithium-Iron Phosphate Nanostructures:

Solution 1: A water soluble iron precursor (iron sulfate (FeSO₄.7H₂O, concentration from 0.001M-1M) solution was dissolved in a mixture of degassed water and triethylene glycol (TEG), where this water/TEG mixture can range from almost 100% water to almost 100% TEG with specific volumetric ratios in between depending on desired product.

Solution 2: An aqueous solution (concentration was 3 times that of the Fe concentration) of LiOH.H₂O was prepared and mixed with TEG.

Solution 3: An equimolar (to iron) solution of H₃PO₄ was then added to Solution 1.

Solution 4: Solution 3 was combined with Solution 2 and the pH was adjusted to a desired level by adding an aqueous solution of H₂SO₄.

Solution 5: An aqueous solution of a polymer (a variety of polymers can be selected with a specific pendant group to control size and morphological features) was mixed with solution 4.

Solution 6: The pH of solution 5 was adjusted to the desired level by adding an aqueous solution of H₂SO₄.

Solution 6 was added to a Teflon lined stainless steel autoclave. The reactor was then sealed and heated to a temperature between 150° C.-200° C. for 2 hours-12 hours to enable hydrolysis and condensation (necessary reaction steps to synthesize lithium-iron phosphate nanostructures from the precursors). The reaction temperature does not have to be 150° C. although a minimum of 50° C. should be used to enable the hydrolysis and condensation of the iron-based precursor. After the reaction, the product was collected and washed with water to remove any unreacted precursors and polymers. The resulting product was then air dried at 40° C. for about 16 hours. The resulting lithium-iron phosphate nanostructures were then used in the construction of battery cells.

These reactions, however, are not limited to lithium-iron phosphate nanostructures and can be used to modify metal nanostructures (Au, Pd, Pt, Ru, Ni, etc.), metal oxide nanostructures (ZnO, Co₃O₄, ZrO₂, RuO₂, SnO₂, Al₂O₃), metal nitride (Si₃N₄, BN, GaN), or any combination of inorganic nanostructures.

Annealing of LiFePO4 Powders. Solvothermally synthesized polycrystalline LFP powders were ground with a mortar and pestle prior to annealing. The ground powder was placed in an alumina boat and heated in a sealed tube furnace in 95% N₂/5% H₂, forming gas at 20 cc/min from 200° C.-700° C. for 3 h, and subsequently cooled to ambient temperature for characterization and electrochemical analysis. The forming gas aided in the reduction of residual Fe³⁺ (to yield Fe²⁺) in the as-synthesized LFP.

Carbon Coating. To produce uniformly coated particles, a polymer solution-based method was used (Sample A). Briefly, a 10% PEG solution was prepared by dissolving a specific amount of polymer in degassed Milli-Q water until a clear solution formed. Concurrently, a 1 wt % LFP suspension was made by adding a specific quantity of LFP powder to degassed Milli-Q water and sonicated for 3 min. The LFP suspension was then added drop-by-drop to a stirred polymer solution at ambient temperature for 1 h to completely mix the polymer and LFP particles. The mixed suspension was then centrifuged at 8000 rpm for 5 min and dried in vacuo at 70° C. for 5 h. The dried samples were then placed in an alumina boat and annealed in a sealed tube furnace under 20 cm³/min flowing 95% N₂/5% H₂ forming gas at 600° C. for 3 h.

To produce carbon-coated particles using a traditional solid-state method (Sample B), as-synthesized LFP powders and sucrose (10 wt %) were weighed and mixed in a glass jar containing alumina beads (weight ratio of alumina beads to LFP/sucrose powder was 20:1). This mixture was mechanically ground for 30 h using a rolling instrument. After being ground, the mixture was placed in an alumina boat and annealed in an alumina tube furnace under 20 cm3/min flowing 95% N₂/5% H₂ forming gas at 600° C. for 3 h.

A control specimen (Sample C), which did not contain carbon, was produced by annealing polycrystalline LFP under the same conditions as Samples A and B (i.e., at 600° C. under 20 cm³/min flowing 95% N₂/5% H₂ forming gas for 3 h).

Material Characterization. Phase identification was determined by X-ray diffraction analysis (XRD, Philips X′Pert) using Cu Kα radiation. Using the resulting XRD diffraction patterns, the crystallite diameters were calculated based on the Scherer formula. Particle sizes and morphologies were observed using a scanning electron microscope (SEM, FEI XL30) at 10-20 kV accelerating voltage. To investigate the behavior of LFP during annealing, thermal and mass analyses was performed using a thermal gravimetric analyzer/differential scanning calorimeter (TGA/DSC, TA Instruments Q600), annealed from 25 to 700° C. (heating rate of 10° C./min) with a 3 h hold at 700° C. in 95% N₂/5% H₂. Raman spectroscopy measurements were carried out at ambient temperature using a 532 nm laser as the excitation source at 1 mW power. The total carbon content of coated LFP samples was analyzed using a PerkinElmer 2400 II CHN analysis from Tucson Laboratory of ALS (Australian Laboratory Services) environmental center. A transmission electron microscope (TEM, FEI CM300), operated at 300 kV, was used to identify the carbon coating thickness.

Electrochemical Performance. As-prepared LFP powders (either samples A, B or C), conductive carbon black (Super P), and polyvinylidene fluoride (PVDF, 78:14:8 wt %) were mixed in N-methylpyrrolidone (NMP) to produce a slurry. This viscous slurry was subsequently coated on an aluminum foil current collector. The coated film was dried in the vacuum oven at 100° C. for 12 h. Coin cells (R2032 type) were assembled in an argon-filled glovebox, consisting of the prepared positive electrode, lithium metal foil as the negative electrode, Celgard polymer as a separator and 1.0 M LiPF₆ in ethylene carbonate (EC)-diethyl carbonate (DEC) (50:50 vol %) as the electrolyte solution. The loading of the active material was 1.5-2 mg/cm². The cyclic performance and rate capability of LFP batteries were tested using an Arbin battery test system (Arbin Instruments, Model BT2043). Cyclic voltammograms were run on a VMP3 multichannel electrochemical station.

Annealing. Thermal Behavior of LiFePO₄. To obtain an optimum annealing temperature for the carbon coating process, the thermal behavior of synthesized polycrystalline LFP was analyzed by TGA/DSC (see FIG. 14). Thermal analyses revealed that the synthesized polycrystalline LFP was stable beyond 600° C. but underwent a reduction reaction above 700° C. in 95% N₂/5% H₂. Based on these results, a systematic investigation of the effects of annealing at different temperatures (i.e., from 200° C. to 700° C.) was performed on the resulting crystalline and particle structures. X-ray diffraction of LFP annealed between 200° C. and 600° C. confirmed the presence and stability of the orthorhombic olivine-type structure (JCPDS #81-1173)20 and significant crystal growth above 500° C. (see

FIG. 4). Corroborating evidence of an increase in crystalline size above 400° C. is seen in the endothermic peaks at 398° C., 505° C., and 570° C. from the DSC curve in FIG. 14. The sample annealed at 700° C. for 3 h transformed to the Fe₂P phase (see FIG. 4), reflecting the reduction of LFP under N₂/H₂ at higher temperatures. The reduction in material weight above 600° C. from thermal gravimetric analysis confirmed this transformation (see FIG. 14).

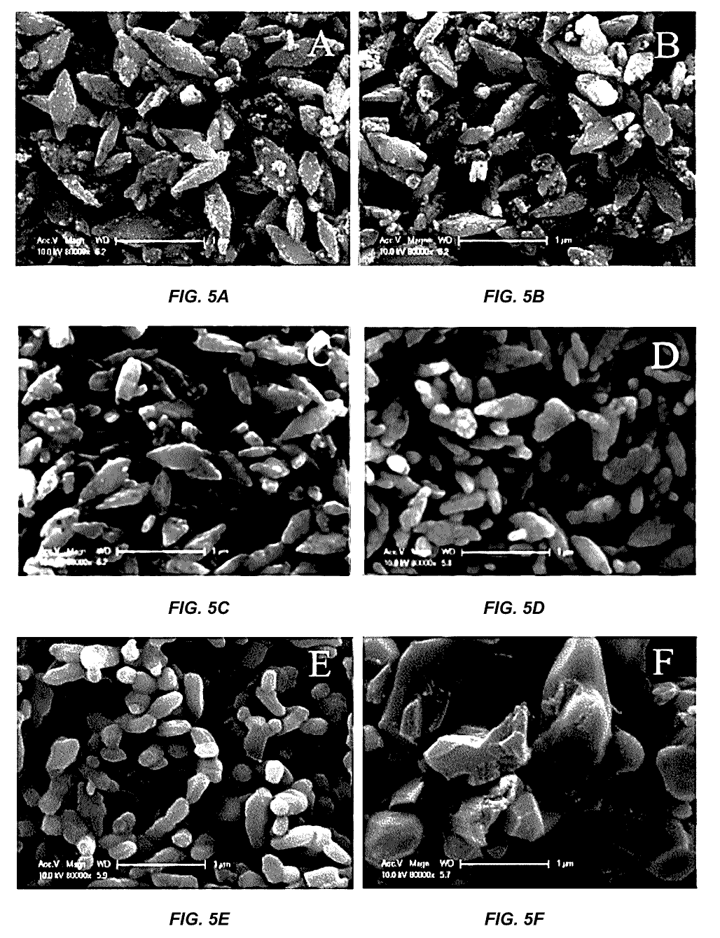

Morphological changes were also observed (see FIG. 5) for samples heat-treated at various temperatures. By 400° C., smaller nanoparticles were not observed, and the surfaces of larger particles became smoother. By 500° C., particle sizes decreased with increasing crystallite size, and the particles appeared more rounded. By 600° C., the diamond-like morphology of particles was no longer evident, and some faceting was observed. By 700° C., a clear change in particle size and morphology had occurred. XRD of this sample confirmed the Fe₂P phase, explaining this significant change (see FIG. 4 line F). The apparent decrease in secondary particle size upon annealing from 200° C. to 600° C. can be explained based on the initial formation mechanism of LFP under hydro-solvothermal methods. After nucleation, the charge on primary particles decreases, allowing their approach to each other, eventually yielding polycrystalline secondary particles via oriented attachment, but with some porosity. During annealing, an increase in crystal size (peak sharpness from FIG. 4 lines C-E) and a decrease in the number of grain boundaries per particle was observed (eventually yielding more single crystal-like particles; see FIG. 5E).

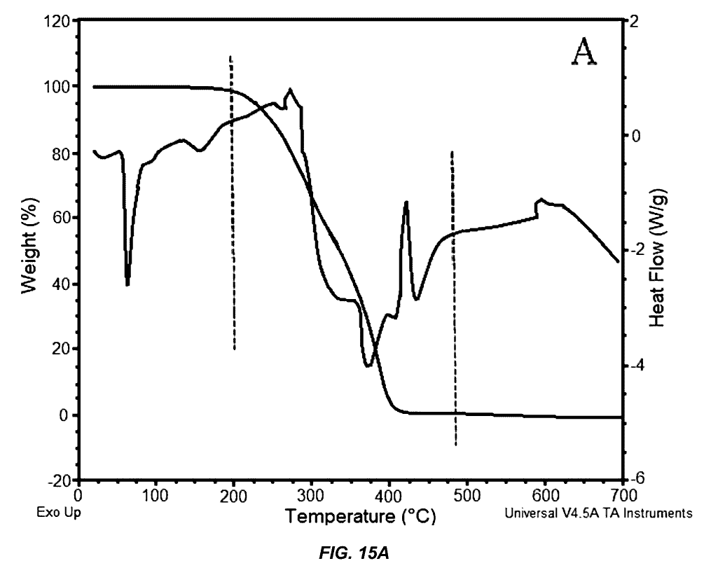

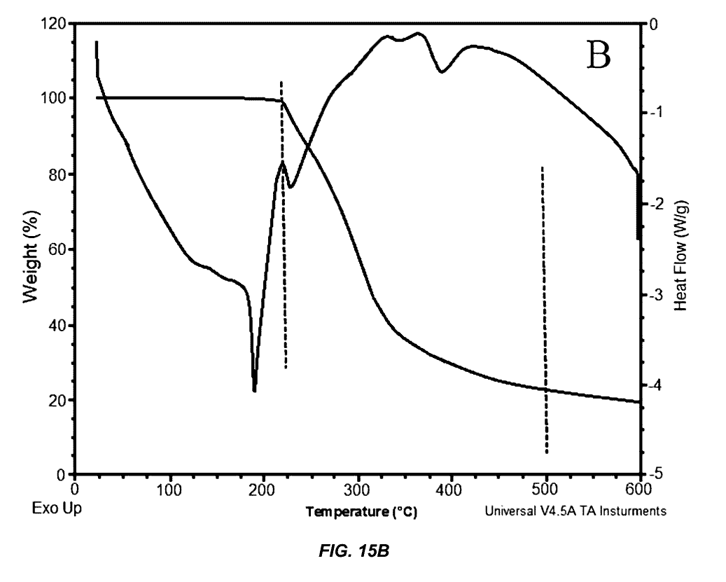

Thermal Behavior of PEG and Sucrose. Thermal analyses of polyethylene glycol and sucrose additives, heated in 95% N₂/5% H₂ from 25° C. to 700° C. were investigated using TGA/DSC (see FIG. 15). PEG starts to decompose at ˜225° C., and its decomposition is completed by 400° C. with only a small amount of carbon remaining (0.5 wt %). A similar TGA/DSC trend was also observed for sucrose, initiating at 225° C., but degrading more slowly over a broader temperature range. To analyze the resulting carbon structure, micro-Raman analyses was conducted for residues after various heat treatments for both PEG and sucrose sources.

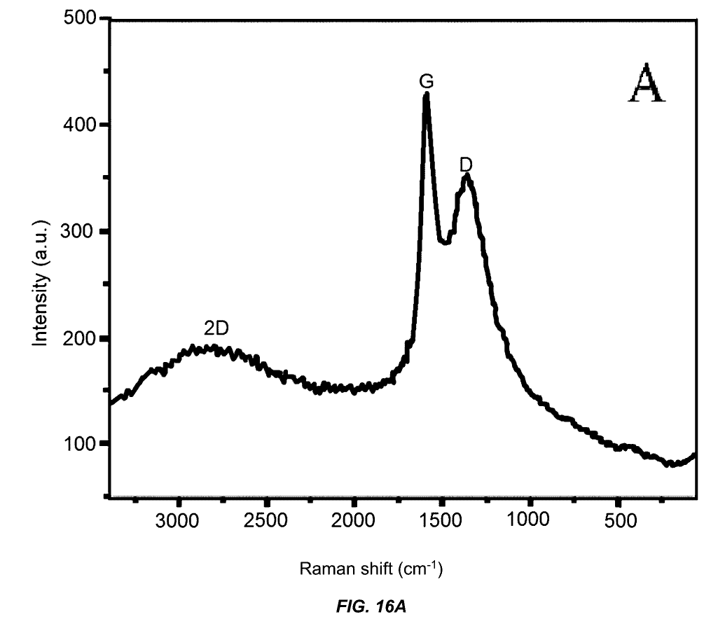

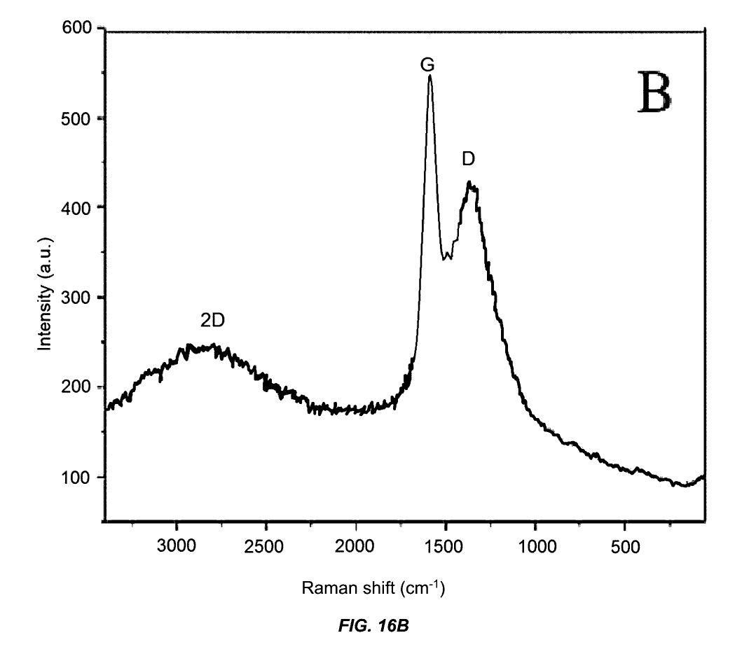

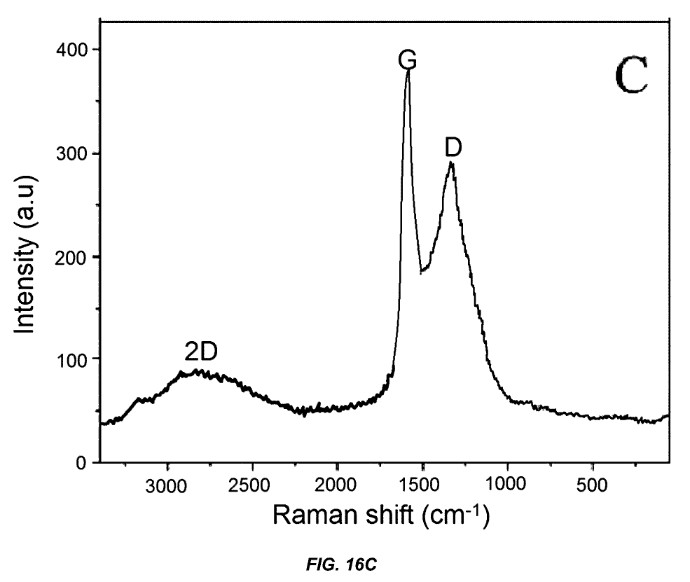

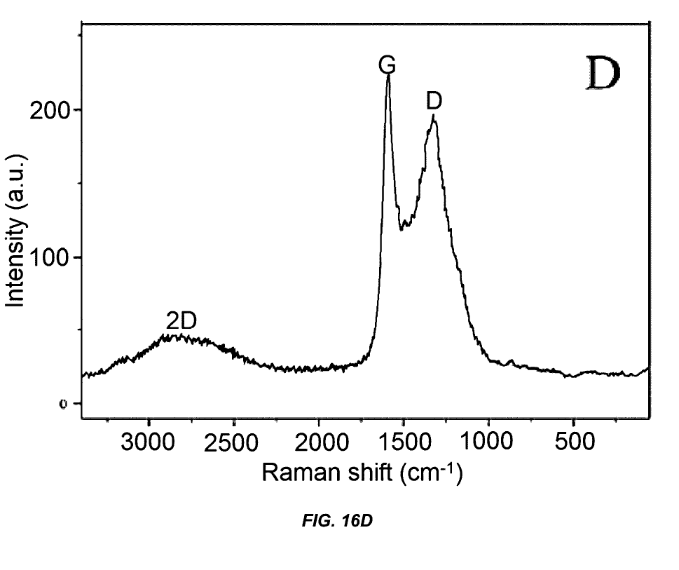

Raman has been widely used to detect and differentiate graphitic versus disordered carbon. Graphitized carbon is known to have a better electronic conductivity compared to disordered carbon. On the basis of observations from TGA/DSC (see FIG. 15), PEG samples were annealed in 95% N₂/5% H₂ (20 cc/min) at four temperatures (400° C., 500° C., 600° C., and 700° C.) for 3 h to investigate the resulting ordering in the resulting carbon structures (see FIG. 16). All of the Raman spectra (see FIG. 16) consist of two intense peaks at 1355 and 1584 cm⁻¹, corresponding to the disordered (D) and graphitic (G) bands of carbon, respectively. The third broad peak at 2710 cm⁻¹ is attributed to the 2D band (D peak overtone), which originates from a process where momentum conservation is satisfied by two phonons with opposite wave vectors. It is clear that for all samples, the graphitic peak at 1584 cm⁻¹ showed a higher intensity compared to the disordered carbon peak at 1355 cm⁻¹, indicating a good expected electronic conductivity. Upon careful examination of these peaks, a trend in the ratio of G/D was identified (see Table 1). The G/D ratio increased from 400° C. to 600° C., then decreased at 700° C. The decreased graphitic peak intensity ratio is due to the disruption of layered carbon structure at high temperatures in the forming gas (the exothermic peak at 600° C. in FIG. 15).

TABLE 1
Structural Carbon Data from Annealed PEG and Sucrose Sources.

| Carbon | Annealing | Intensity |
|---|---|---|
| Source | Temperature (° C.) | ration of G/D |
| PEG | 400 | 1.30 |
| PEG | 500 | 1.36 |
| PEG | 600 | 1.36 |
| PEG | 700 | 1.15 |
| Sucrose | 500 | 1.20 |
| Sucrose | 600 | 1.43 |

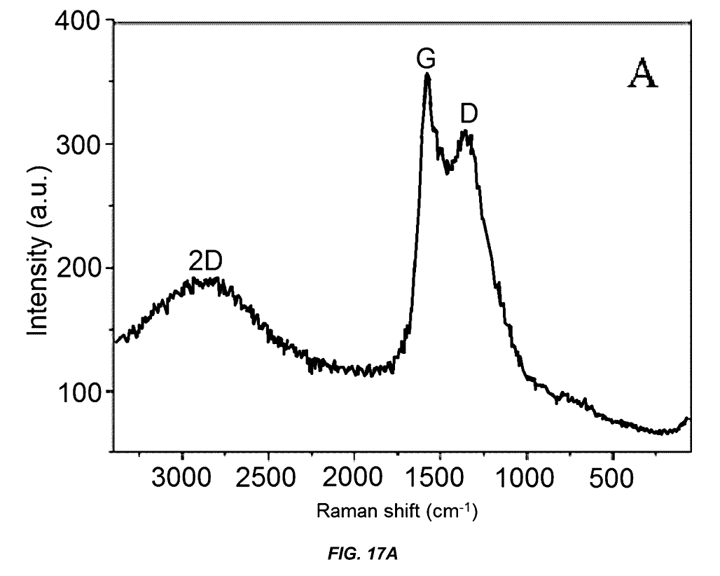

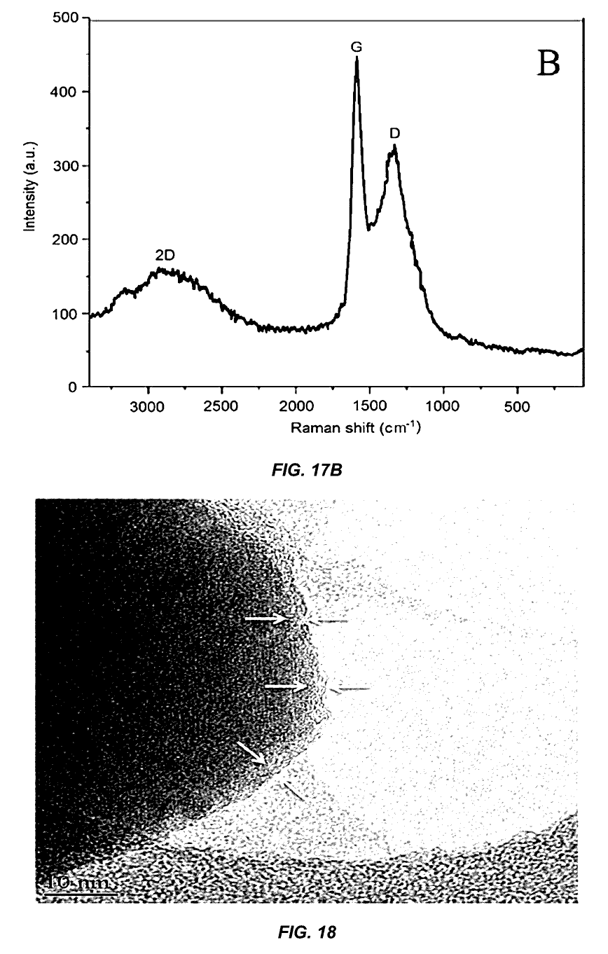

On the basis of an increasing ratio of G/D from 500° C. to 600° C. for sucrose (see FIG. 17), an annealing temperature of 600° C. was chosen for carbon coatings on LFP.

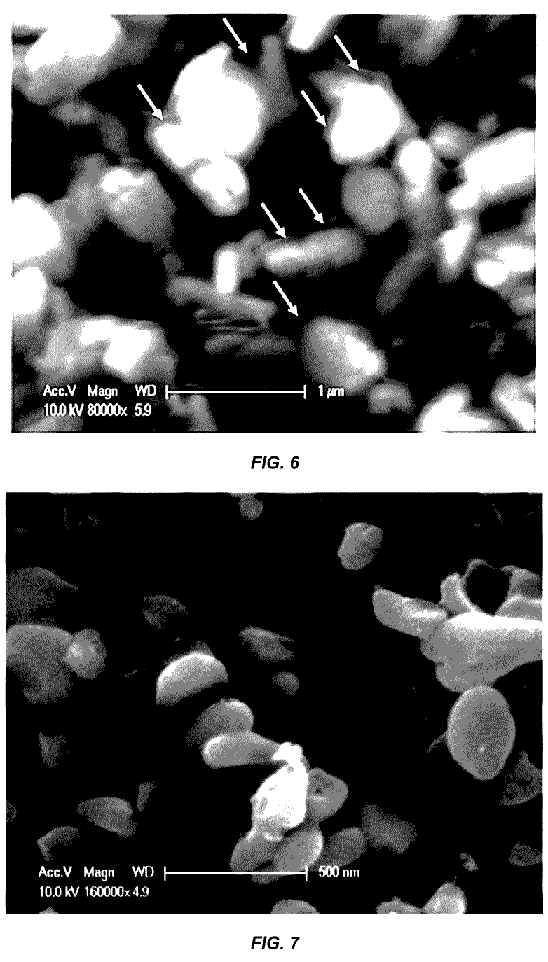

Carbon-Coated LiFePO4 from PEG (Sample A). PEG Solution-based Coatings. The morphology of coated particles (as-synthesized polycrystalline LFP suspension mixed with the PEG solution), were studied via SEM. FIG. 6 reveals that the surfaces of LFP were surrounded by a ˜50 nm organic coating (i.e., PEG thin film) that, upon heating, yielded an evenly distributed carbon layer. The uniformity with which PEG coats the LFP particles can be explained by their interactions. The solution pH of 1 wt % LFP in water is ˜10.5 (caused by the reaction of Li with water). Thus, the surfaces of LFP will be negatively charged (from previous zeta potential results of LFP16). Aqueous PEG solutions (10 wt %) have a pH=7.3. Based on the pKa value of PEG (14-16), the polymers were expected to be positively charged, and thus it can electrostatically bind with the LFP surface. In addition, synthesis of these particles (i.e., using a mixed hydro-solvothermal method), would likely lead to a high density of hydroxyl groups bound to the surface of the LFP. These surface hydroxyls would enable hydrogen bonding with the PEG functional groups, leading to a more conformal coating.

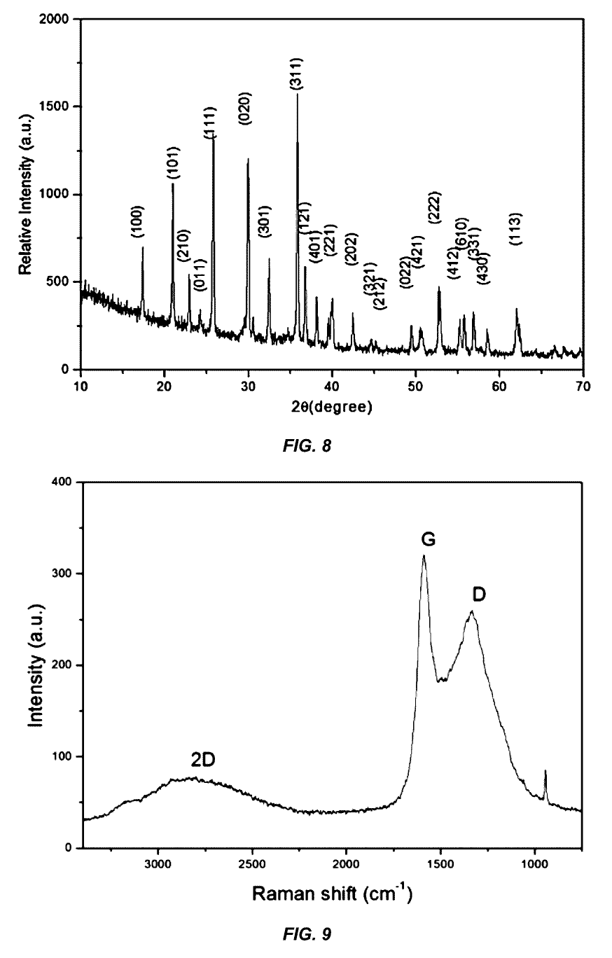

Carbon-Coated LFP from PEG. After the LFP was coated with PEG, samples were annealed at 600° C. in forming gas for 3 h. SEM micrographs (see FIG. 7) display a similar morphology as the as-synthesized LFP16 but with a reduction in smaller nanoparticles and grain boundaries. This is likely due to sintering of smaller grains during annealing. XRD (see FIG. 8) confirms the material is pure LFP without any detectable impurities (e.g., such as FeP or Fe₂P). The crystallite size of the LFP, coated with polymer, was calculated to be 52 nm using the Scherer equation (Table 2).

TABLE 2
Crystal size and Carbon Content for Samples A, B, and C after
Heat Treatment in 95% N₂/5% H₂ for 3 hours at 600° C.

| | | crystal | particle | carbon content |
|---|---|---|---|---|
| | polymer | size | size | after annealing |
| sample | added | (nm) | (nm) | (wt %) |
| A | PEG added | 52 | 457 nm ± 154 | 0.41 |
| B | sucrose (wt. 10%) | 41 | 340 nm ± 180 | 2.64 |
| C | added control | 81 | 488 nm ± 94 | 0 |
| | (w/o polymer) | | | |

Raman analysis of the resulting carbon structure for PEG-coated LFP after annealing reveals that the G/D ratio is the same (1.30) as pure PEG heat-treated under the same conditions and is comparable or even better than previous reports (see FIG. 9). The less intense peak at 946 cm⁻¹ is ascribed to the symmetric vibration of the PO₄ groups in LFP. On the basis of the high ratio of graphitic carbon to disordered carbon, these coated LFP particles were expected to display good electronic conductivity, with better high-rate discharge capacities in cells. TEM observations (see FIG. 18) of this sample were conducted to probe the coating structure. The outer surface of the particle contains a very thin coating (˜1-2 nm thick, highlighted by arrows). Raman spectroscopy, which probes a significantly larger volume of material than by TEM, showed a relatively high graphitic-to disordered ratio, and it is therefore likely that a large fraction of these coatings is graphitic. However, the potential orientation of the graphite within these coatings is unknown and further investigations are in progress.

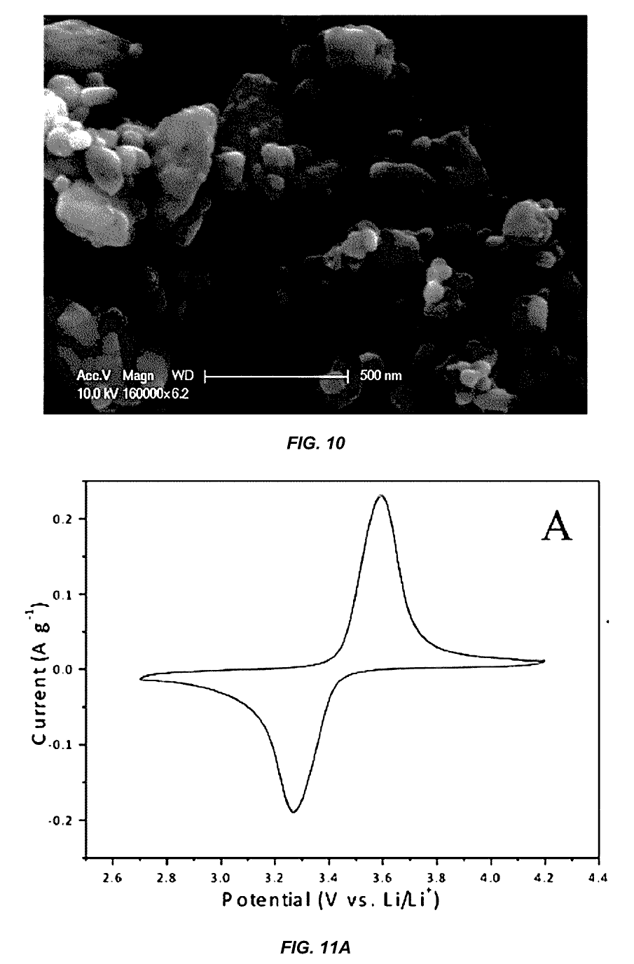

Carbon-Coated LiFePO4 from Sucrose (Sample B). Sucrose, a commonly used source of carbon in battery materials, was also selected to investigate its effect as a carbon coating on the polycrystalline LFP. As mentioned previously, sucrose was mechanically mixed with LFP and subsequently annealed in forming gas to 600° C. (the same as PEG-coated LFP). FIG. 10 shows that particles tend to be more aggregated compared to the PEG added LFP, which is likely due to heterogeneities from a solid-state mixing process, whereas the solution method utilized a homogenized suspension of LFP particles.

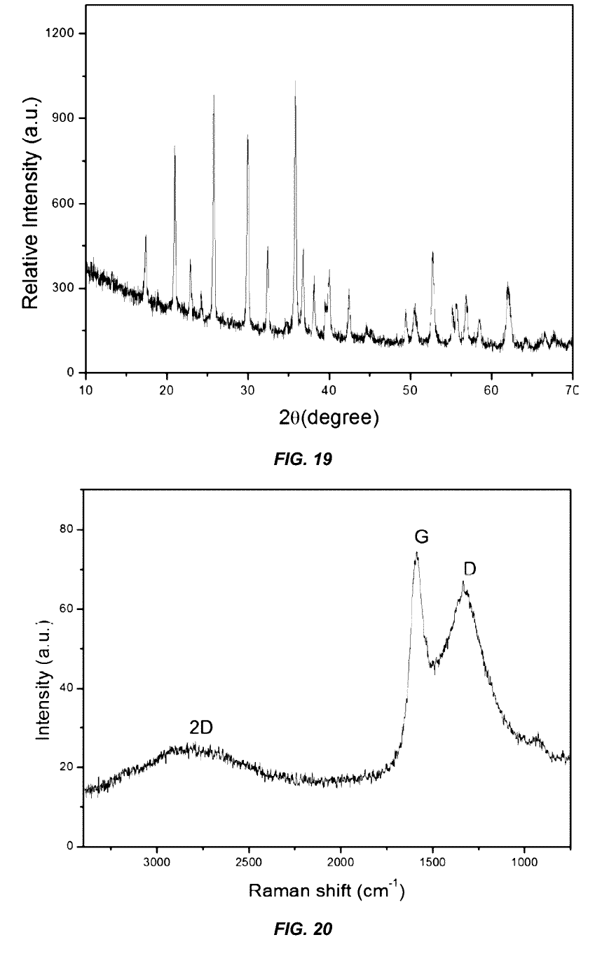

XRD confirmed that the LFP was pure by not detecting any impurities (see FIG. 19). The crystal size was calculated to be 41 nm (as determined from the Scherer equation; see Table 2), which is smaller compared to the PEG added LFP. This difference in crystallite size is likely due to the extra energy provided for crystal growth by the exothermic decomposition of PEG (see FIG. 15). Specifically, there is an exothermic peak at 425° C. in PEG but no exothermic peak observed in the decomposition of sucrose.

Raman spectroscopy uncovered the resulting carbon structure for the sucrose-based, carbon-coated LFP after annealing in forming gas to 600° C. (see FIG. 20). The spectrum is very similar to the PEG-based carbon-coated LFP, with a slightly lower G/D ratio of 1.20.

To determine carbon content in annealed samples, C/H/N elemental analyses was performed on samples A and B (see Table 2). The carbon content in sample A (PEG-based carbon coated LFP) is only 0.41 wt % compared to 2.64 wt % carbon in sample B (sucrose added LFP). Thus, the tap density should be greater for sample A, which would increase the energy density of constructed batteries. In addition, the PEG-based carbon coated LFP showed a high concentration of graphitic carbon and had small crystallite sizes and an evenly distributed particle size, which should display excellent electrochemical performance.

A carbon-free LFP (sample C), heat-treated at 600° C. for 3 h in 95% N₂/5% H₂ at 20 cc/min, was used as a control. XRD (see FIG. 4 line E) confirmed the pure LFP phase and SEM (see FIG. 5E) revealed a decrease in particle size along with an increased crystal size (see Table 2).

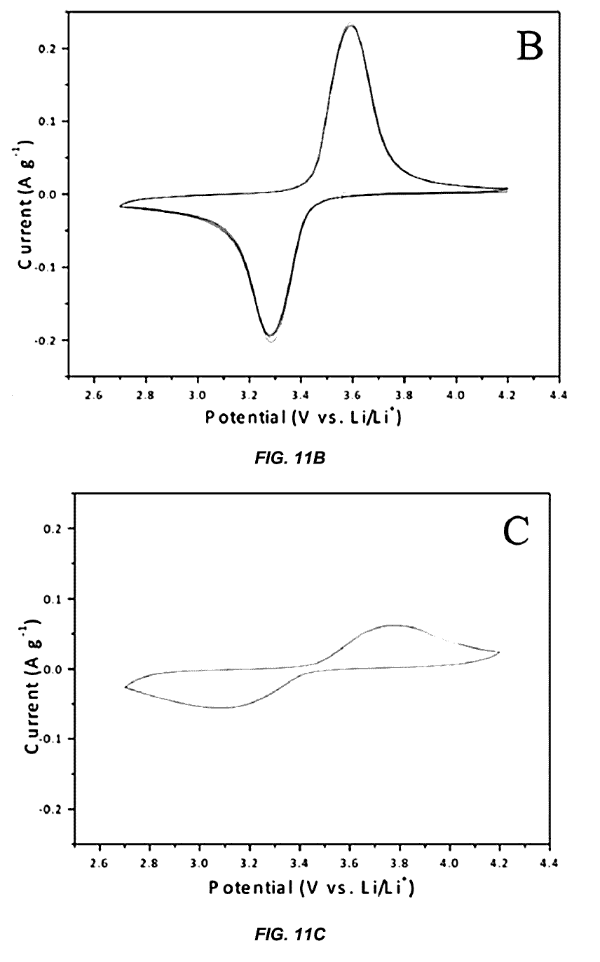

Electrochemical Performance of LiFePO₄. Cyclic Voltammetry. Cyclic voltammetry (CV) (see FIG. 11), performed on all samples at a scan rate of 0.1 mV/s at ambient temperature for three cycles, displays an oxidation peak and a reduction peak, corresponding to the charge/discharge reactions of the Fe²⁺/Fe³⁺ redox couple. Each of the second and third scans display similar profiles as the first, suggesting the good reversibility of these cathodes. The PEG-based carbon-coated LFP (sample A) displayed a voltage hysteresis of 0.32 V with a peak current of 0.23 A/g, while the carbon-free LFP (control sample C) had a voltage difference of 0.60 V and a peak current of 0.11 A/g. It is known that smaller voltage differences between the charge and discharge, as well as higher peak currents, indicate better electrode reaction kinetics and thus better rate performance. The results demonstrate that carbon-coated LFP have enhanced kinetics compared to carbon-free LFP during the lithiation and delithiation due to the increased electronic conductivity through carbon coating. A comparison of carbon-coated samples A and B reveals a similar voltage hysteresis (0.32 V for sample A and 0.31 V for sample B) and the same peak current (0.23 A/g for both A and B), indicating similar kinetic behavior, even though sample A has a much lower carbon content (0.41%) compared to sample B (2.64%). Thus, the solution-processed carbon coating yields impressive performance but will have greater enhanced tap density and thus a higher volumetric energy density.

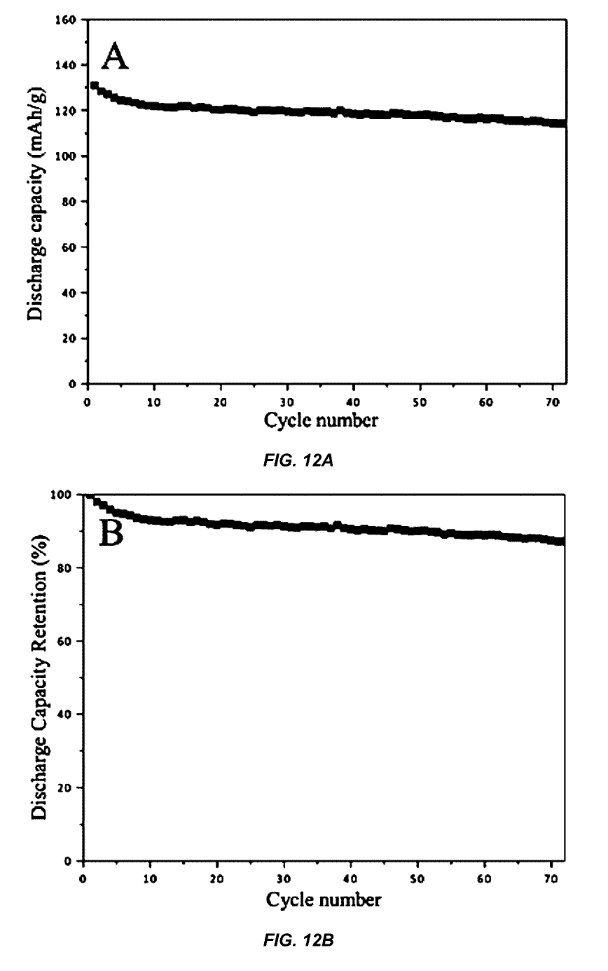

Charge/Discharge Capacity. FIG. 12 shows the galvanostatic discharge capacity as a function of cycle number for carbon-coated LFP (sample A) at a current density of 16 mA/g. The cells can deliver 130 mAh/g capacity after 70 cycles with ˜92% capacity retention (see FIG. 9), indicating excellent cycle stability. It was reported that very small (<2%) amounts of carbon can effectively increase the capacity retention. Here, with less than 0.5% carbon in the LFP, the capacity retention was increased dramatically.

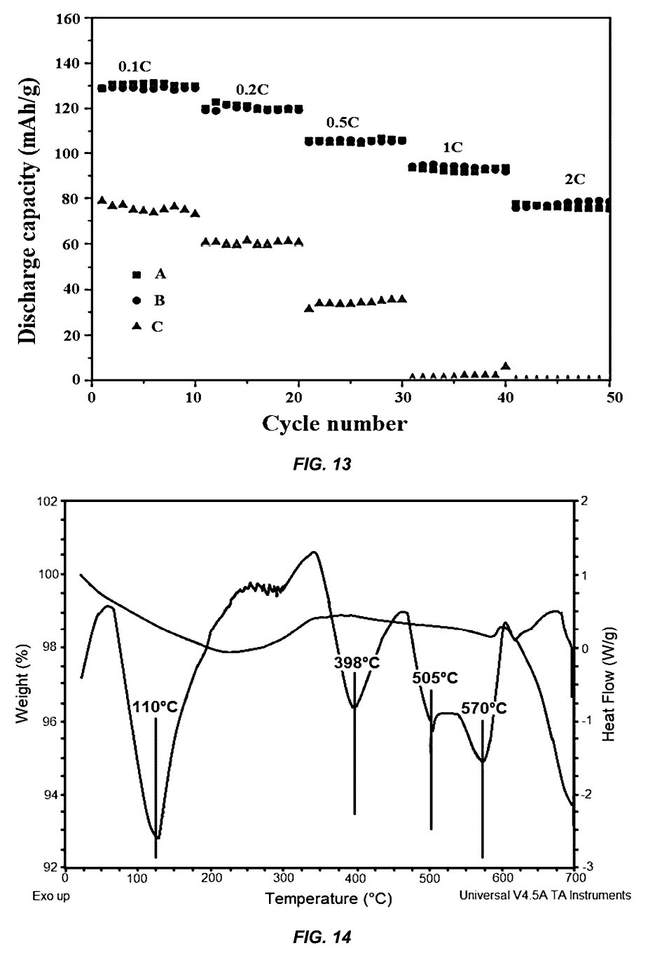

The specific discharge capacities at different current rates (from 16 mA/g to 320 mA/g) for samples A, B, and C are shown in FIG. 13. Uncoated LFP (sample C) delivers 115 mAh/g at 0.1 C, which is better than the other reported data for carbon-free LFP (60 mA h/g at 0.1 C). After coating with 0.41 wt % carbon, the capacity significantly increased (black ▪). The remarkable advantage of this carbon-coated material is its high rate capability (80 mA h/g at 2 C) with extremely low carbon content. Its performance is comparable with the 2.64 wt % coated LFP (blue ). Thus, with low quantities of carbon additive, the tap density of LFP increased from 1.1 to 1.8 g/cm3 with a 40% increase in volumetric density.

A number of embodiments have been described herein. Nevertheless, it will be understood that various modifications may be made without departing from the spirit and scope of this disclosure. Accordingly, other embodiments are within the scope of the following claims.

What is claimed is:

1. A method to generate a conformational conductive coating on particles comprising the steps of:
adding a plurality of particles to a solution comprising an organic polymer dissolved in one or more solvents;
incubating the particles in the solution until a coating of the organic polymer forms on the surface of the particles;
isolating the organic polymer-coated particles; and
pyrolyzing the organic polymer-coated particles in an inert and/or reducing atmosphere at 200° C. to 800° C. for 1 to 24 hours so that the organic polymer coating anneals and decomposes to form a conformal carbon coating that is electrically conductive on the surface of the particles that is 0.5 nm to 10 nm in thickness,
wherein the particles are nano- to micron-sized particles that are comprised of an insulating material used for anodes or cathodes.

2. The method of claim 1, wherein the one or more solvents comprise a polar protic solvent.

3. The method of claim 1, wherein the organic polymer is selected from the group consisting of poly(vinyl alcohol), polyethylene, poly(butyl methacrylate), poly(α-methylstyrene), polyethylene glycols, polystyrene, polypropylene, polytetrafluoroethylene, polychlorotrifluoroethylene, para-aramid, polychloroprene, polyamide, polyacrylonitrile, copolyamid, polytetrafluroethylene, polyimide, aromatic polyester, poly-p-phenylene-2,6-benzobisoxazole, poly-4-vinylphenol, poly(2,6-diphenylphenylene oxide), poly(3,4-ethylenedioxythiphene), poly(hexamethylene carbonate), poly(hydridocarbyne), poly(methacrylic acid), poly(N-vinylacetamide), poly(p-phenylene oxide), polyphenylene sulfide, poly(p-phenylene vinylene), polyacetylene, polyallylamine hydrochloride, polyaniline, polyaniline nanofibers, polyaryletherketone, polybenzimidazole fiber, polybutadiene, polydiacetylenes, polydioctylfluorene, polyetherketoneketone, polyglycerol, polyricinoleate, polyhexahydrotriazine, polyhexamethylene guanidine, polyketone, polymacon, polymethylpentene, polyol, polybenzyl isocyanate, polypyridinium salts, polypyrrole, polystyrene sulfonate, polythiophene, cellulose, chitin, glycogen, polypeptides, polynucleotides, and polysaccharides.

4. The method of claim 1, wherein the polymer is polyethylene glycol or a functionalized polyethylene glycol.

5. The method of claim 4, wherein the solution comprises 5% to 30% by weight of polyethylene glycol or a functionalized polyethylene glycol.

6. The method of claim 1, wherein the plurality of particles is added from a suspension comprising evenly dispersed particles.

7. The method of claim 6, wherein the suspension comprises from 0.5% to 10% by weight of the particles in a polar protic solvent.

8. The method of claim 6, wherein the suspension is added drop by drop to an agitated solution comprising the organic polymer dissolved in one or more solvents.

9. The method of claim 1, wherein the solution comprising the particles and polymer is incubated under agitation for 0.5 hours to 3 hours at 15° C. to 30° C.

10. The method of claim 1, wherein the particles are isolated by centrifugation, by aggregation with salt, by sedimentation, and/or by evaporation.

11. The method of claim 1, wherein the particles are dried prior to the heating step.

12. The method of claim 1, wherein the particles are comprised of LiFePO₄.

13. The method of claim 1, wherein the organic polymer-coated particles are pyrolyzed under a flowing 95% N₂/5% H₂ forming gas.

14. The method of claim 13, wherein the organic polymer-coated particles are pyrolyzed at about 600° C. for two to four hours.

15. The method of claim 1, wherein the carbon coating is evenly distributed over the particle' surface, and wherein the carbon content of the carbon coated particle is less than 1% by weight.

16. Conformational conductive coated particles made by the method of claim 1.

17. The particles of claim 16, wherein the conformational conductive coated particles exhibit one or more of the following characteristics:
a carbon coating from about 1 nm to 2 nm;
a large portion of the coating is graphitic versus disordered carbon;
a crystal size from 42 to 80 nm;
a G/D ration of about 1.30;
a particle size from 300 nm to 620 nm; and/or
a rate capability of about 80 mA h/g at 2 C.

18. A cathode comprising the particles of claim 16.

19. A lithium ion battery comprising the cathode of claim 18.
